(19) United States
(12) Patent Application Publication
(10) Pub. No.: US 2005/0106441 A1
(43) Pub. Date: May 19, 2005

(54) Hydrogen cartridge, fuel cell system and method of attaching hydrogen cartridge

(75) Inventors: Jun Yamamoto, Kawasaki-shi (JP); Masaaki Shibata, Tokyo (JP)

Correspondence Address: FITZPATRICK CELLA HARPER & SCINTO, 30 ROCKEFELLER PLAZA, NEW YORK, NY, 10112, US

(73) Assignee: CANON KABUSHIKI KAISHA, TOKYO (JP)

(21) Appl. No.: 10/949,284

(22) Filed: Sep. 27, 2004

(30) Foreign Application Priority Data
Sep. 30, 2003 (JP) 2003-339799(PAT.)

(51) Int. Cl. H01M 8/04; B65D 85/00

(52) U.S. Cl. 429/34; 206/.6

(57) ABSTRACT

There are provided a hydrogen cartridge for a fuel cell for supplying hydrogen to a fuel cell body comprising a hydrogen storage chamber for storing hydrogen, a movable part which is movably connected to the hydrogen storage chamber and has a hydrogen flow path for allowing hydrogen to flow therethrough, and a hydrogen supply port which is formed integrally with the movable part and communicates with the hydrogen flow path, wherein the cartridge takes an open state in which the hydrogen storage chamber, the hydrogen flow path and the hydrogen supply port are connected to each other, or a closed state in which the hydrogen storage chamber, the hydrogen flow path and the hydrogen supply port are not connected to each other, by movement of the movable part or the hydrogen storage chamber, and a fuel cell system having the hydrogen cartridge incorporated therein, whereby it is possible to prevent leakage of hydrogen due to unstable connection between the hydrogen cartridge and a fuel cell body and to assure safety in handling.

### BACKGROUND OF THE INVENTION

1. Field of the Invention

The present invention relates to a hydrogen cartridge used for a fuel cell which uses hydrogen gas as a fuel, a fuel cell system using the same, and a method of attaching the hydrogen cartridge, in particular, to a hydrogen cartridge for an electronic device having a fuel cell body therein and a method of attaching the same.

2. Related Background Art

In recent years, in the field of electronics, multifunctionalization and increase in amount of data to be processed in portable small electronic devices such as cellular phones, personal digital assistants (PDA), notebook personal computers, digital cameras and digital camcorder involve increased power consumption. A battery to be mounted in such a device has been strongly required to have a higher energy density and a longer service life.

In the meantime, a fuel cell converts a chemical energy obtained by chemically reacting hydrogen with oxygen directly into an electrical energy and can therefore have a high power-generation efficiency and can generate an energy per unit volume or per unit weight in a large amount which is several to about ten times that of a conventional battery. Extensive studies on such a fuel cell have been made in order to mount the fuel cell in vehicles such as automobiles, use the fuel cell for cogeneration systems for home use, and apply the fuel cell to portable electronic devices, for example.

The fuel cell for generating an electrical energy from hydrogen has a hydrogen electrode to which hydrogen is supplied and an oxygen electrode to which oxygen is supplied. The hydrogen electrode splits hydrogen into electrons and protons by a catalytic reaction. The protons pass through an electrolyte membrane to reach the oxygen electrode, where the protons are reacted with oxygen by a catalytic reaction to produce water. In this process, a flow of electrons, that is, a power is produced.

There are various fuel cells such as a phosphoric acid fuel cell, a molten carbonate fuel cell, a solid oxide fuel cell, and a polymer electrolyte fuel-cell. A polymer electrolyte fuel cell is particularly suitable for a small electronic device. This is because the polymer electrolyte fuel cell is advantageous in that the cell can be used at a temperature near ordinary temperature, and is portable with safety because the electrolyte is not a liquid but a solid.

Of the polymer electrolyte fuel cell, the direct hydrogen polymer electrolyte fuel cell using pure hydrogen as a fuel has an excellent system efficiency, is a zero-emission type cell that does not emit any substances other than water, and has attracted attention as a power source alternative to a conventional secondary battery. Furthermore, the fuel cell does not have to be charged, unlike a conventional secondary battery. When the fuel cell is filled with a fuel after the fuel is exhausted, the fuel cell can generate power immediately. The fuel cell can be conveniently used for a device for long-term use.

Examples of modes in which the fuel cell is applied to a portable small electronic device include a mode in which a whole fuel cell system is incorporated in a portable small electronic device and filled with hydrogen directly, a mode in which a whole fuel cell system is attachable/detachable and exchanged, and a mode in which a hydrogen cartridge that is attachable to and detachable from a fuel cell body is exchanged. The last mode is disclosed in Japanese Patent Application Laid-Open No. 2002-158020 and is particularly advantageous to fuel circulation.

As a technique for storing hydrogen in a small hydrogen cartridge at a high density, there are known a technique of storing hydrogen in the form of molecules such as a high-pressure gas, liquefied hydrogen, or an adsorbed state, a technique of storing hydrogen as a metal hydride (such as a hydrogen storage alloy or chemical hydride), a technique of storing hydrogen as an organic compound (such as cyclohexane or decalin), and the like. Of these, a hydrogen cartridge having a hydrogen storage alloy incorporated therein is particularly mentioned as a hydrogen cartridge that is small and suitable for portable use, can be filled with hydrogen at a high density, and is safe for handling.

As described above, if a hydrogen cartridge is prepared, an electrical energy can be generated whenever and wherever, by filling the cartridge with the fuel. However, there are problems with handling of hydrogen gas. Since hydrogen has an extremely broad combustible range when mixed with air (combustible range: 4 to 74%), and explodes both in a small concentration and in an extremely large concentration, hydrogen is a substance that needs to be handled very carefully. Hydrogen, when flown outdoors, will be diffused in the atmosphere, thereby reducing the risk to be mixed with oxygen. However, in a closed system in which hydrogen is continuously leaked out from a storage container such as a tank at a small flow rate, hydrogen may remain without diffusion.

In addition, a hydrogen molecule, which is the smallest naturally occurring substance, is shielded only with difficulty and is very liable to leak out.

Accordingly, a fuel cell system is required to be provided with a hydrogen cartridge from which hydrogen does not leak out. The leakage of hydrogen gas is liable to occur particularly when a hydrogen cartridge is connected to a fuel cell body. A conventional hydrogen cartridge forms a flow path at the same time as connection to a fuel cell body, whereby hydrogen is supplied to the fuel cell body. Therefore, if the hydrogen cartridge is loosely connected to the fuel cell body, connection between the cartridge and the fuel cell body is kept to be unstable, thereby causing problems, in particular, increased possibility of leakage of hydrogen.

Moreover, when a fuel cell is applied to a portable small electronic device, size reduction of a hydrogen cartridge is indispensable. However, there are disadvantages such that the size reduction of a hydrogen cartridge makes it inconvenience to attach/detach the hydrogen cartridge to/from a fuel cell body by human hands, and possibility of leakage of hydrogen due to loose connection between the hydrogen cartridge and the fuel cell body increases. A method is conceivable in which a connector between a hydrogen cartridge and a fuel cell body is provided with a holder or a connector-releasing mechanism so that the hydrogen cartridge can be conveniently attached to and detached from the fuel cell body. However, considering that a hydrogen cartridge is to be installed in a small electronic device, it is preferable that unnecessary mechanisms are as less as possible.

The present invention has been accomplished in view of such a background art. An object of the present invention is to provide a hydrogen cartridge that can prevent leakage of hydrogen due to unstable connection between the hydrogen cartridge and a fuel cell body, when the hydrogen cartridge is attached to and detached from the fuel cell body, and is safe for handling.

Another object of the present invention is to provide a fuel cell to which the hydrogen cartridge is attached. A further object of the present invention is to provide an attaching method that allows easy attachment of the hydrogen cartridge to a fuel cell easily.

### SUMMARY OF THE INVENTION

The present invention has made to achieve the above objects.

According to a first aspect of the present invention, there is provided a hydrogen cartridge for a fuel cell for supplying hydrogen to a fuel cell body, comprising a hydrogen storage chamber for storing hydrogen, a movable part which is movably connected to the hydrogen storage chamber and has a hydrogen flow path for allowing hydrogen to flow therethrough, and a hydrogen supply port which is formed integrally with the movable part and communicates with the hydrogen flow path, wherein the cartridge takes an open state in which the hydrogen storage chamber, the hydrogen flow path and the hydrogen supply port are connected to each other, or a closed state in which the hydrogen storage chamber, the hydrogen flow path and the hydrogen supply port are not connected to each other, by movement of the movable part or the hydrogen storage chamber.

In the present invention, it is preferred that the hydrogen cartridge takes the open state or the closed state by revolving movement of the movable part such that the hydrogen supply port is rotated with respect to the hydrogen storage chamber about an axis in a direction of the hydrogen supply port.

Further, it is preferred that the hydrogen cartridge takes the open state or the closed state by revolving movement of the hydrogen storage chamber such that the hydrogen storage chamber is revolved about an axis in a direction of the hydrogen supply port.

Moreover, it is preferred that the hydrogen cartridge takes the open state or the closed state by folding movement of the movable part such that the hydrogen supply port is folded with respect to the hydrogen storage chamber within the range between a direction of an axis of the hydrogen supply port and a direction perpendicular to the direction of the axis of the hydrogen supply port.

Further, it is preferred that the hydrogen cartridge takes the open state or the closed state by folding movement of the hydrogen storage chamber such that the hydrogen storage chamber is folded with respect to the hydrogen supply port within the range between a direction of an axis of the hydrogen supply port and a direction perpendicular to the direction of the axis of the hydrogen supply port.

According to a second aspect of the present invention, there is provided a fuel cell system comprising a fuel cell body; and a hydrogen cartridge attached to the fuel cell body, for supplying hydrogen to the fuel cell body, the hydrogen cartridge comprising a hydrogen storage chamber for storing hydrogen, a movable part which is movably connected to the hydrogen storage chamber and has a hydrogen flow path for allowing hydrogen to flow therethrough, and a hydrogen supply port which is formed integrally with the movable part and communicates with the hydrogen flow path, wherein the cartridge takes an open state in which the hydrogen storage chamber, the hydrogen flow path and the hydrogen supply port are connected to each other, or a closed state in which the hydrogen storage chamber, the hydrogen flow path and the hydrogen supply port are not connected to each other, by movement of the movable part or the hydrogen storage chamber.

According to a third aspect of the present invention, there is provided a-method of attaching a hydrogen cartridge for a fuel cell to a fuel cell body disposed in a casing of an electronic device, the method comprising the steps of attaching to a fuel cell body outside a casing of an electronic device a hydrogen cartridge for supplying hydrogen to the fuel cell body, comprising a hydrogen storage chamber for storing hydrogen, a movable part which is movably connected to the hydrogen storage chamber and has a hydrogen flow path for allowing hydrogen to flow therethrough, and a hydrogen supply port which is formed integrally with the movable part and communicates with the hydrogen flow path, wherein the cartridge takes an open state in which the hydrogen storage chamber, the hydrogen flow path and the hydrogen supply port are connected to each other, or a closed state in which the hydrogen storage chamber, the hydrogen flow path and the hydrogen supply port are not connected to each other, by movement of the movable part or the hydrogen storage chamber; then moving the movable part of the hydrogen cartridge; and subsequently housing the hydrogen cartridge in the casing of the electronic device.

With the present invention, after confirming that the hydrogen cartridge is normally connected to the fuel cell body, the movable part or the hydrogen storage chamber can be operated to supply hydrogen. Further, after operating the movable part or the hydrogen storage chamber to stop the hydrogen supply, the hydrogen cartridge can be detached from the fuel cell body. Therefore, when the hydrogen cartridge is attached to or detached from the fuel cell body, leakage of hydrogen due to unstable connection between the hydrogen cartridge and the fuel cell body can be prevented, so that a hydrogen cartridge is provided which can be handled with safety.

Further, when the hydrogen cartridge of the present invention has the configuration in which either the movable part or the hydrogen storage chamber is folded with respect to the other, even the hydrogen cartridge requiring size reduction enough to be installed in a portable small electronic device can be attached to and detached from the fuel cell body conveniently by human hands, which can prevent leakage of hydrogen due to loose connection between the hydrogen cartridge and the fuel cell body and risks involved in the leakage. Moreover, a location at which the hydrogen cartridge is connected to the fuel cell body and a location in which the hydrogen cartridge is housed can be separately designed. Therefore, the degree of freedom in layout of the inside of a casing of an electronic device, in which the fuel cell is incorporated, can be more increased.

The present invention can also provide a fuel cell system having the hydrogen cartridge incorporated therein.

The present invention can further provide an attaching method that allows attachment of the hydrogen cartridge to a fuel cell body easily.

Other features and advantages of the present invention will be apparent from the following description taken in conjunction with the accompanying drawings.

### BRIEF DESCRIPTION OF THE DRAWINGS

FIG. 1 is a diagram showing the configuration of a portable small electronic device in which a fuel cell system having the hydrogen cartridge of the present invention incorporated therein is installed;

FIG. 2 is a perspective view showing a first embodiment of the hydrogen cartridge of the present invention;

FIG. 3 is a partial perspective view for illustrating the movable part of the hydrogen cartridge of FIG. 2;

FIG. 4A is a sectional view taken along line 4-4 in FIG. 2 for showing the hydrogen cartridge of FIG. 2 in an open state, and FIG. 4B is a sectional view taken along line 4-4 in FIG. 2 for showing the hydrogen cartridge of FIG. 2 in a closed state;

FIG. 5 is a perspective view showing a second embodiment of the hydrogen cartridge of the present invention;

FIG. 6A is a partial sectional view taken along line 6-6 in FIG. 5 for showing the movable part of the hydrogen cartridge of FIG. 5 in an open state, and FIG. 6B is a partial sectional view taken along line 6-6 in FIG. 5 for illustrating the movable part of the hydrogen cartridge of FIG. 5 in a closed state;

FIG. 7 is a schematic view showing an example in which the hydrogen cartridge of the present invention is installed in a portable small electronic device; and

FIG. 8 is a schematic view showing the hydrogen cartridge of the present invention housed in a portable small electronic device.

### DETAILED DESCRIPTION OF THE PREFERRED EMBODIMENTS

The present invention will now be described in detail with reference to the drawings.

The hydrogen cartridge of the present invention is characterized by having a hydrogen storage chamber for storing hydrogen, a movable part which is movably connected to the hydrogen storage chamber and has a hydrogen flow path for allowing hydrogen to flow therethrough, and a hydrogen supply port which is formed integrally with the movable part and communicates with the hydrogen flow path, wherein the cartridge takes an open state in which the hydrogen storage chamber, the hydrogen flow path and the hydrogen supply port are connected to each other, or a closed state in which the hydrogen storage chamber, the hydrogen flow path and the hydrogen supply port are not connected to each other, by movement of the movable part or the hydrogen storage chamber.

The hydrogen cartridge in accordance with a first embodiment of the present invention is characterized by revolving movement of the movable part such that the hydrogen supply port is rotated with respect to the hydrogen storage chamber, specifically about an axis in a direction of the hydrogen supply port.

The hydrogen cartridge in accordance with a second embodiment of the present invention is characterized by revolving movement of the hydrogen storage chamber such that the hydrogen storage chamber is revolved about an axis in a direction of the hydrogen supply port.

The hydrogen cartridge in accordance with a third embodiment of the present invention is characterized by folding movement of the movable part such that the hydrogen supply port is folded with respect to the hydrogen storage chamber within the range between a direction of an axis of the hydrogen supply port and a direction perpendicular to the direction of the axis of the hydrogen supply port.

The hydrogen cartridge in accordance with a fourth embodiment of the present invention is characterized by folding movement of the hydrogen storage chamber such that the hydrogen storage chamber is folded with respect to the hydrogen supply port within the range between a direction of an axis of the hydrogen supply port and a direction perpendicular to the direction of the axis of the hydrogen supply port.

With the hydrogen cartridge having such a configuration, after attaching to the fuel cell body followed by confirmation of normal connection, by moving the movable part or the hydrogen storage chamber, the open state is established such that the hydrogen storage chamber communicates with the hydrogen supply port via the hydrogen flow path, so that hydrogen can be supplied through the hydrogen supply port to the fuel cell body. Further, also when detaching the hydrogen cartridge from the fuel cell body, by moving the movable part or the hydrogen storage chamber to block the flow path thereby stopping the hydrogen supply, the hydrogen cartridge can be detached from the fuel cell body. Therefore, when the hydrogen cartridge is attached to or detached from the fuel cell body, leakage of hydrogen due to unstable connection between the hydrogen cartridge and the fuel cell body can be prevented, so that a hydrogen cartridge is provided which can be handled with safety.

Further, with the hydrogen cartridge of the configuration in which the movable part is folded, after attaching to the fuel cell body outside a casing of an electronic device having the fuel cell system incorporated therein, by folding the movable part of the hydrogen cartridge with respect to the hydrogen storage chamber, the hydrogen cartridge can be housed in the casing of the electronic device. Further, also when detaching the hydrogen cartridge, it is possible to take the hydrogen cartridge housed in the casing of the electronic device out from the casing and then to detach the hydrogen cartridge. Therefore, even the hydrogen cartridge requiring size reduction enough to be installed in a portable small electronic device can be attached to and detached from the fuel cell body conveniently by human hands, which can prevent leakage of hydrogen due to loose connection between the hydrogen cartridge and the fuel cell body and risks involved in the leakage.

Moreover, in a casing of an electronic device, a location at which the hydrogen cartridge is connected to the fuel cell body and a location at which the hydrogen cartridge is housed can be separately designed. Therefore, in an electronic device in which the hydrogen cartridge and the fuel cell body are installed, the degree of freedom in layout of the inside of the casing can be increased.

Preferred embodiments of the present invention will be described in detail below with reference to the drawings.

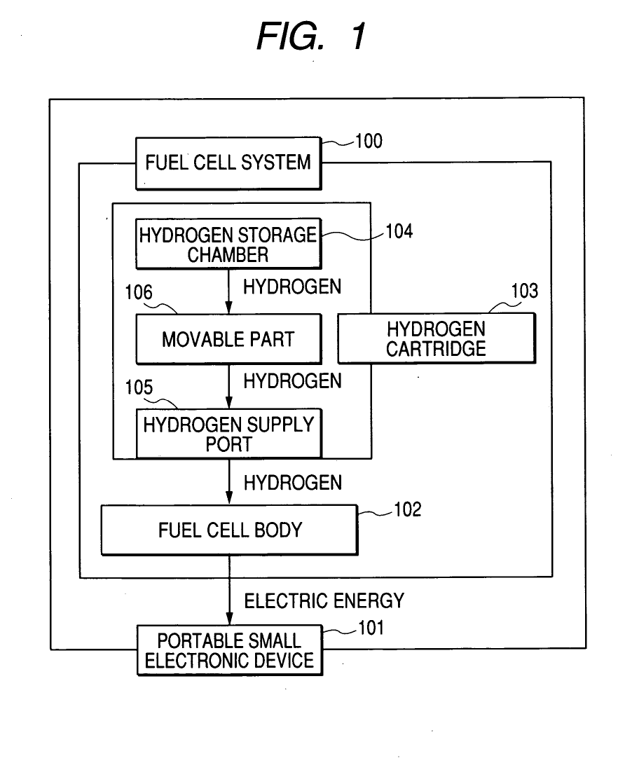

FIG. 1 is a diagram showing the configuration of a portable small electronic device in which a fuel cell system having the hydrogen cartridge of the present invention incorporated therein is installed. A portable small electronic device 101 having a fuel cell system 100 installed therein houses a fuel cell body 102 in a casing and is configured such that a hydrogen cartridge 103 is attachable to and detachable from the fuel cell body 102.

Any fuel cell unit (not shown) that makes up the fuel cell body 102 may be used as long as the unit uses hydrogen as a fuel, with a polymer electrolyte fuel cell being preferably used in which a polymer electrolyte membrane such as of a perfluorosulfonic acid cation-exchange resin is used; a porous carbon film carrying a catalyst such as platinum is used both as an oxygen electrode and as a fuel electrode; and the polymer electrolyte membrane sandwiched by the both electrodes is used as a membrane/electrode bonded member.

Here, a configuration is adopted in which oxygen is supplied from outside air to the oxygen electrode, and hydrogen is supplied from the hydrogen cartridge to the fuel electrode. The fuel cell body 102 is preferably disposed on an outermost wall of the casing of the electronic device. The wall of the casing of the electronic device on which the fuel cell body 102 is disposed is provided with an air hole for taking outside air therein, through which oxygen used for the reaction is taken in. This hole also has functions of letting produced water as water vapor pass outside and letting heat generated by the reaction pass outside.

The polymer electrolyte membrane used usually has a thickness of about 50 to 100 μm in order to maintain the mechanical strength and prevent a fuel gas from permeating therethrough. This polymer electrolyte membrane usually has a pressure resistance of about 0.3 to 0.5 Pa (3 to 5 kg/cm²). Accordingly, in order to prevent fracture of the membrane by a differential pressure, it is preferable that the differential pressure between the oxygen electrode side and the fuel electrode side in the fuel cell is controlled so as to be 0.05 Pa (0.5 kg/cm²) or less in a normal state and to be 0.1 Pa (1 kg/cm²) or less in emergency.

The hydrogen cartridge 103 has a hydrogen storage chamber 104 and a hydrogen supply port 105, with a movable part 106 having a hydrogen flow path provided therebetween. Since the hydrogen supply port 105 is formed integrally with the movable part 106 and communicates with the hydrogen flow path, the hydrogen supply port 105 is moved with respect to the hydrogen storage chamber 104 to move the movable part 106, so that the cartridge takes an open state in which the hydrogen storage chamber 104, the hydrogen flow path and the hydrogen supply port 105 are connected to each other, or a closed state in which the hydrogen storage chamber 104 is not connected to the hydrogen flow path.

The hydrogen storage chamber 104 contains a hydrogen storage alloy in which hydrogen can be stored. Since the pressure resistance of the polymer electrolyte membrane used in the fuel cell is 0.3 to 0.5 MPa as described above, the alloy is required to be used with a differential pressure between outside air and the inside of the hydrogen storage chamber of 0.1 MPa or less. As a hydrogen storage alloy with a hydrogen release pressure of 0.2 MPa at room temperature, LaNi₅ is used, for example. Further, when a hydrogen storage material with a hydrogen release pressure of above 0.2 MPa at room temperature is used, a regulator for reducing pressure is provided between the hydrogen storage chamber and the fuel electrode.

A procedure for connecting the hydrogen cartridge of the present invention to the fuel cell body will be described. First, the hydrogen cartridge filled with hydrogen is in a closed state in which the flow path between the hydrogen storage chamber and the hydrogen supply port is blocked to prevent hydrogen from leaking from the hydrogen supply port to outside. In this closed state, the hydrogen supply port of the hydrogen cartridge is connected to the fuel cell body. Then, the movable part is operated so that the flow path between the hydrogen storage chamber and the hydrogen supply port is unblocked. Hydrogen is thus supplied from the hydrogen storage chamber to the fuel cell body.

### EXAMPLES

The present invention is further described by reference to the following examples. The following examples are given for the purpose of illustration and not by way of limitation.

### Example 1

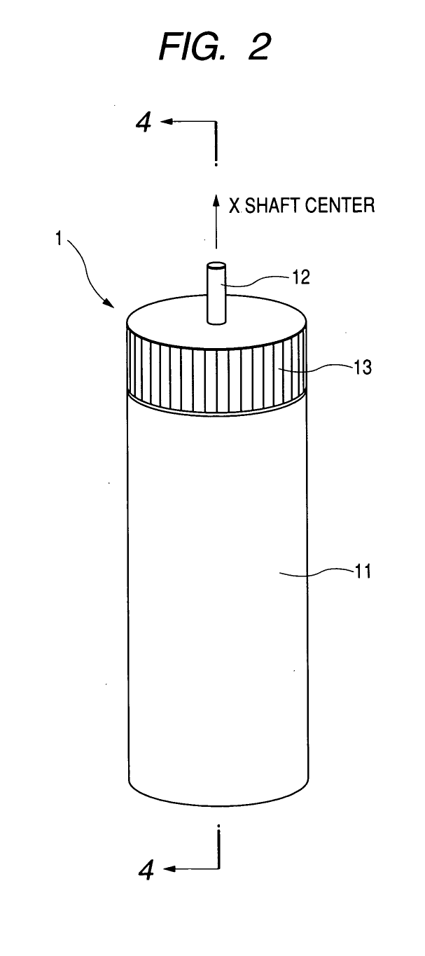

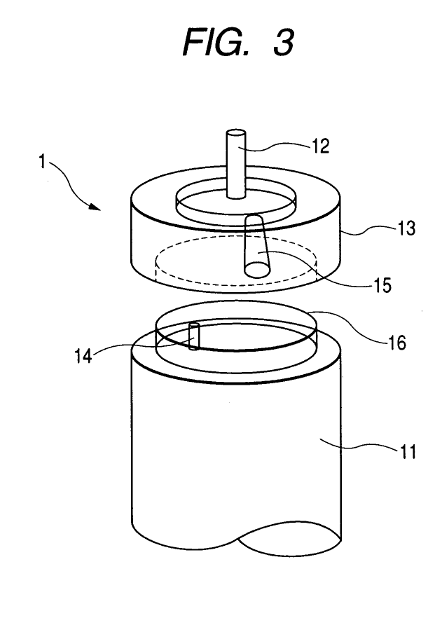

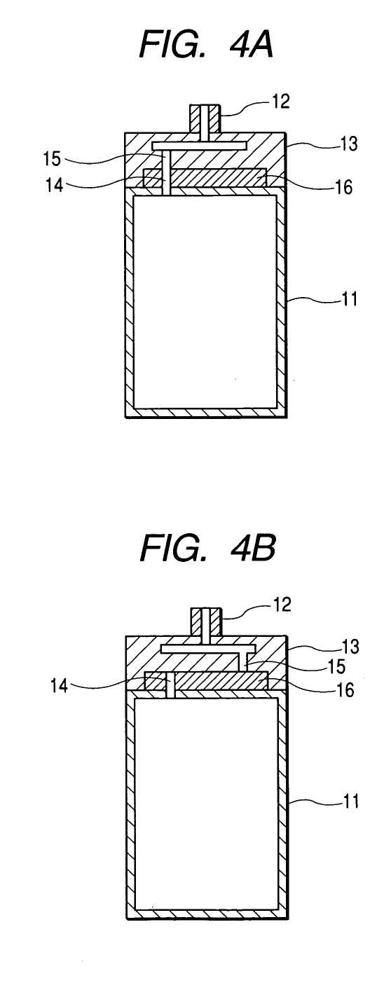

FIG. 2 is a perspective view showing a first embodiment of the hydrogen cartridge of the present invention. FIG. 3 is a partial perspective view for illustrating the movable part of the hydrogen cartridge of FIG. 2. FIG. 4A is a sectional view taken along line 4-4 in FIG. 2 for showing the hydrogen cartridge of FIG. 2 in which the hydrogen flow path is in an open state. FIG. 4B is a sectional view taken along line 4-4 for showing the hydrogen cartridge of FIG. 2 in which the hydrogen flow path is in a closed state.

As shown in the figures, a hydrogen cartridge 1 has a hydrogen storage chamber 11 for storing hydrogen, a hydrogen supply port 12 which is connected to a fuel cell body to supply hydrogen thereto, and a movable part 13 which has a hydrogen flow path 15 therein and is rotatable about an axis X parallel to the hydrogen supply port.

The hydrogen storage chamber 11 contains a hydrogen storage alloy such as LaNi₅ in which hydrogen can be stored. The hydrogen supply port 12 is formed integrally with the movable part 13, and communicates with the hydrogen flow path 15 provided in the movable part 13.

The movable part 13 can rotate (or revolve) about an axis X. The movable part 13 is rotated to move the hydrogen flow path 15 and the hydrogen supply port 12, so that the hydrogen storage chamber 11, the hydrogen flow path 15 and the hydrogen supply port 12 are connected to each other, which makes it possible to supply hydrogen from the hydrogen cartridge to outside.

The movable part 13 is provided with a stopper (not shown), which defines an upper limit and a lower limit of the rotation angle. Specifically, when the movable part of the hydrogen cartridge in a closed state at the lower limit of the rotation angle is rotated to the upper limit of the rotation angle, the hydrogen cartridge can take an open state. Similarly, when the movable part of the hydrogen cartridge in an open state at the rotation angle upper limit is rotated in the reverse direction to the rotation angle lower limit, the hydrogen cartridge can take a closed state.

The rotatable movement of the movable part may be attained by rotating either the hydrogen supply port or the hydrogen storage chamber. For example, when the hydrogen supply port is connected to the fuel cell body and secured, the hydrogen storage chamber of the hydrogen cartridge is rotated by hands so that the hydrogen paths are connected to and disconnected from each other.

The hydrogen storage chamber 11 is provided and communicates with a hydrogen supply path 14. When the movable part 13 is rotated so that the cartridge is in a closed state, the air hole of the hydrogen supply path 14 communicating with the hydrogen storage chamber 11 is physically pressingly closed. Further, the hydrogen storage chamber 11 is rotated so that the hydrogen supply path 14 pressingly closed is connected to the hydrogen flow path 15 provided in the movable part, whereby the hydrogen supply path 14 is connected to the hydrogen supply port 12 via the hydrogen flow path 15 to enable hydrogen supply.

Here, a part in which the movable part 13 contacts the hydrogen storage chamber 11 is coated with a sealing member 16 to prevent leakage of hydrogen. The sealing member 16 can pressingly close the hydrogen supply path 14 communicating with the hydrogen storage chamber when the cartridge is in a closed state, and can operate the movable part smoothly in the rotational direction during rotational movement.

### Example 2

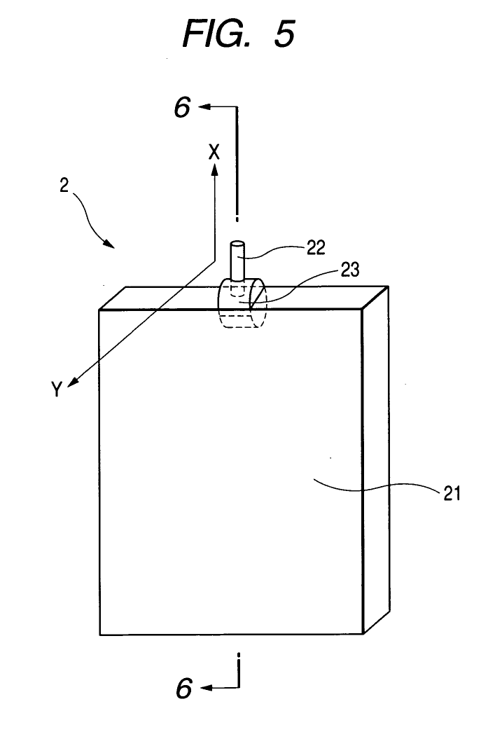

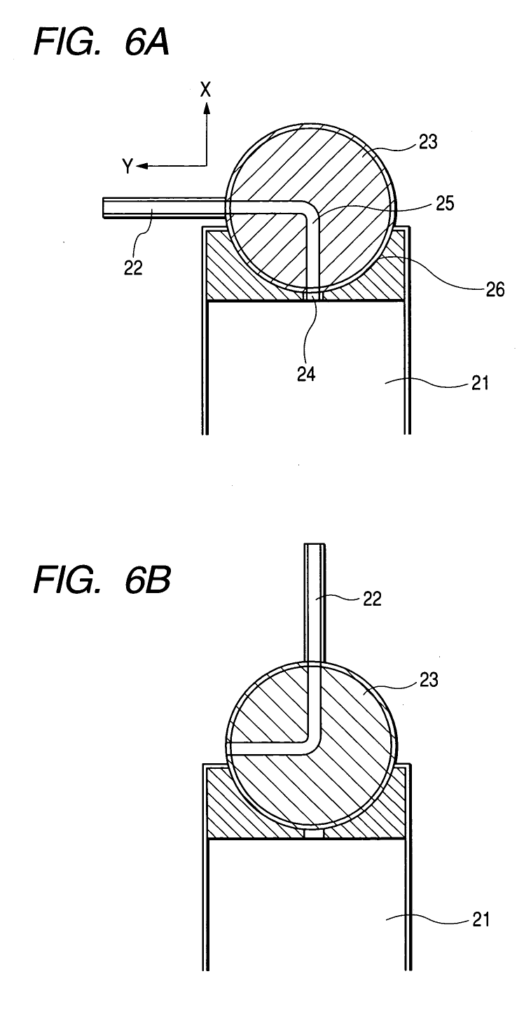

FIG. 5 is a perspective view showing a second embodiment of the hydrogen cartridge of the present invention. FIGS. 6A and 6B are partial sectional views for illustrating the movable part of the hydrogen cartridge. FIG. 6A is a partial sectional view taken along line 6-6 in FIG.5 for illustrating the movable part of the hydrogen cartridge of FIG. 5, in which the hydrogen flow path is in an open state. FIG. 6B is a partial sectional view taken along line 6-6 in FIG. 5 for illustrating the movable part of the hydrogen cartridge of FIG. 5, in which the hydrogen flow path is in a closed state.

A hydrogen cartridge 2 has a hydrogen storage chamber 21 for storing hydrogen, a hydrogen supply port 22 which is connected to a fuel cell body to supply hydrogen thereto, and a movable part 23 which can bend (or pivotally rotate) the hydrogen supply port perpendicularly within the range between a direction parallel to axis X and a direction parallel to axis Y.

The hydrogen storage chamber 21 contains a hydrogen storage alloy such as LaNi₅ in which hydrogen can be stored. The hydrogen supply port 22 is formed integrally with the movable part 23, and communicates with a hydrogen flow path 25 provided in the movable part 23.

The movable part 23 can bend the hydrogen supply port 22 perpendicularly within the range between a direction parallel to axis X and a direction parallel to axis Y. The movable part 23 is rotated to bend the hydrogen supply port 22 so that the hydrogen storage chamber 21, the hydrogen flow path 25 and the hydrogen supply port 22 are connected to each other through a hydrogen supply path 24 provided in an upper wall of the hydrogen storage chamber 21, which enables supply of hydrogen from the hydrogen cartridge to outside.

The movable part 23 is provided with a stopper (not shown), which defines an upper limit and a lower limit of the bend angle. Specifically, when the movable part 23 of the hydrogen cartridge 2 in a closed state at the bend angle lower limit (where the hydrogen supply port 22 is in the direction of the axis X) is bent to the bend angle upper limit (where the hydrogen supply port 22 is in the direction of the axis Y), the hydrogen cartridge can take an open state. Similarly, when the movable part 23 of the hydrogen cartridge 2 in the open state at the bend angle upper limit (where the hydrogen supply port 22 is in the direction of the axis Y) is bent in the reverse direction to the bend angle lower limit (where the hydrogen supply port 22 is in the direction of the axis X), the hydrogen cartridge can take the closed state. Since the hydrogen supply port 22 is connected to a fuel cell body and secured, the hydrogen storage chamber 21 of the hydrogen cartridge 2 is bent by hands so that the hydrogen paths are connected to and disconnected from each other.

When the hydrogen cartridge 2 is in a closed state, the movable part 23 physically pressingly closes the air hole of the hydrogen supply path 24 provided in the upper wall of the hydrogen storage chamber 21. The hydrogen storage chamber 21 is bent by hands so that the hydrogen supply path 24 pressingly closed is connected to the hydrogen flow path 25 provided in the movable part, whereby the hydrogen supply path 24 is connected to the hydrogen supply port 22 via the hydrogen flow path 25, which enables hydrogen supply.

Here, a part in which the movable part 23 contacts the hydrogen storage chamber 21 is coated with a sealing member 26 to prevent leakage of hydrogen. The sealing member 26 can pressingly close the hydrogen supply path 24 for the hydrogen storage chamber 21 when the cartridge is in a closed state, and can operate the movable part smoothly in the bending direction during bending movement.

### Example 3

In this example, a method for attaching the hydrogen cartridge of Example 2 to a portable small electronic device is described.

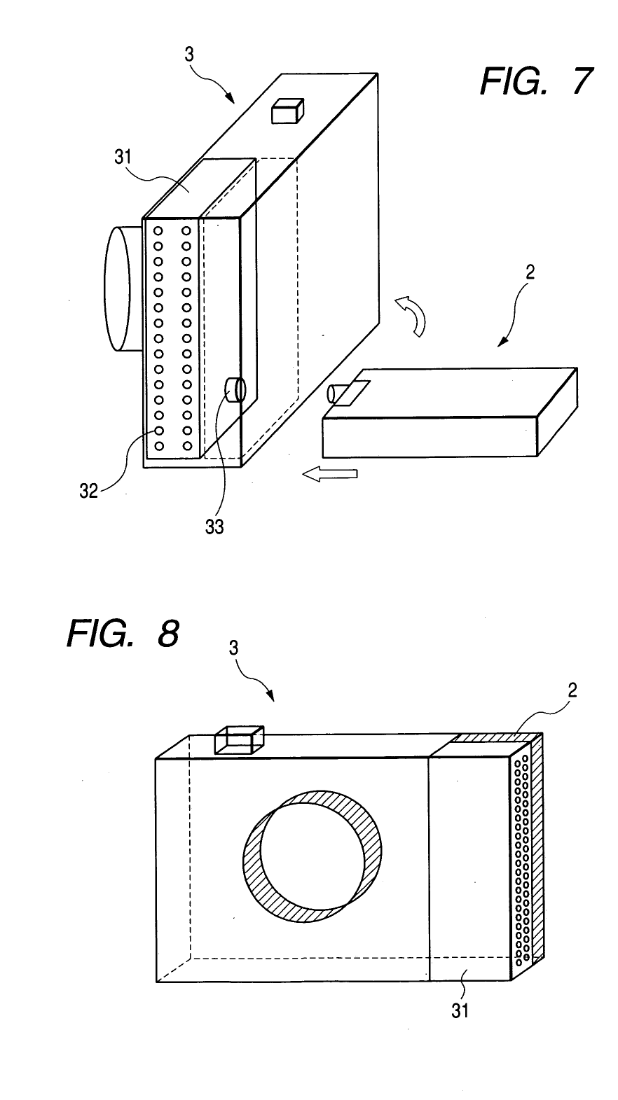

FIG. 7 is a schematic view showing an example in which the hydrogen cartridge 2 is attached to a portable small electronic device, for example, a digital camera. A portable small electronic device 3 contains a fuel cell body 31, and the fuel cell body 31 is preferably disposed on an outermost wall in a casing of the electronic device 3. A wall of the casing of the electronic device 3, on which the fuel cell body 31 is disposed, is provided with an air hole 32 for taking outside air therein, which takes oxygen used for the reaction therein.

The fuel cell body 31 is provided with a connecting part 33 for connection to a hydrogen cartridge 2. The hydrogen cartridge 2 is connected to the connecting part 33, and then perpendicularly folded upwardly to be housed in the casing of the electronic device 3. Here, since hydrogen that is lighter than air is used, hydrogen is preferably supplied to the fuel cell body in a direction from bottom to top in order to supply and diffuse hydrogen to the fuel electrode. The connecting part 33 is preferably disposed below the fuel cell body in the electronic device in normal use.

By connecting the hydrogen cartridge to the fuel cell body outside the casing-of the electronic device, even the hydrogen cartridge requiring size reduction enough to be installed in a portable small electronic device can be attached more conveniently by human hands. This is also true when detaching the cartridge.

FIG. 8 is a schematic view showing the hydrogen cartridge that has been attached to and housed in a portable small electronic device, for example, a digital camera. The location in which the hydrogen cartridge 2 is connected to the fuel cell body and the location in which the hydrogen cartridge 2 is housed can be separately designed. Therefore, in an electronic device in which the hydrogen cartridge 2 and the fuel cell body are installed, the degree of freedom in layout of the inside of the casing can be increased.

The hydrogen cartridge of the present invention can be attached to and detached from the fuel cell body, while preventing leakage of hydrogen due to unstable connection between the hydrogen cartridge and the fuel cell body, and is safe in handling. Therefore, the cartridge can conveniently be used as a hydrogen cartridge for a fuel cell.

In addition, a fuel cell system in which the hydrogen cartridge is incorporated can be used as a fuel cell system for a portable small electronic device.

This application claims priority from Japanese Patent Application No. 2003-339799 filed on Sep. 30, 2003, which is hereby incorporated by reference herein.

1. A hydrogen cartridge for a fuel cell for supplying hydrogen to a fuel cell body, comprising a hydrogen storage chamber for storing hydrogen, a movable part which is movably connected to the hydrogen storage chamber and has a hydrogen flow path for allowing hydrogen to flow therethrough, and a hydrogen supply port which is formed integrally with the movable part and communicates with the hydrogen flow path, wherein the cartridge takes an open state in which the hydrogen storage chamber, the hydrogen flow path and the hydrogen supply port are connected to each other, or a closed state in which the hydrogen storage chamber, the hydrogen flow path and the hydrogen supply port are not connected to each other, by movement of the movable part or the hydrogen storage chamber.

2. The hydrogen cartridge according to claim 1, wherein the cartridge takes the open state or the closed state by revolving movement of the movable part such that the hydrogen supply port is rotated with respect to the hydrogen storage chamber about an axis in a direction of the hydrogen supply port.

3. The hydrogen cartridge according to claim 1, wherein the cartridge takes the open state or the closed state by revolving movement of the hydrogen storage chamber such that the hydrogen storage chamber is revolved about an axis in a direction of the hydrogen supply port.

4. The hydrogen cartridge according to claim 1, wherein the cartridge takes the open state or the closed state by folding movement of the movable part such that the hydrogen supply port is folded with respect to the hydrogen storage chamber within the range between a direction of an axis of the hydrogen supply port and a direction perpendicular to the direction of the axis of the hydrogen supply port.

5. The hydrogen cartridge according to claim 1, wherein the cartridge takes the open state or the closed state by folding movement of the hydrogen storage chamber such that the hydrogen storage chamber is folded with respect to the hydrogen supply port within the range between a direction of an axis of the hydrogen supply port and a direction perpendicular to the direction of the axis of the hydrogen supply port.

6. A fuel cell system comprising:
a fuel cell body; and
a hydrogen cartridge attached to the fuel cell body, for supplying hydrogen to the fuel cell body, the hydrogen cartridge comprising a hydrogen storage chamber for storing hydrogen, a movable part which is movably connected to the hydrogen storage chamber and has a hydrogen flow path for allowing hydrogen to flow therethrough, and a hydrogen supply port which is formed integrally with the movable part and communicates with the hydrogen flow path, wherein the cartridge takes an open state in which the hydrogen storage chamber, the hydrogen flow path and the hydrogen supply port are connected to each other, or a closed state in which the hydrogen storage chamber, the hydrogen flow path and the hydrogen supply port are not connected to each other, by movement of the movable part or the hydrogen storage chamber.

7. A method of attaching a hydrogen cartridge for a fuel cell to a fuel cell body disposed in a casing of an electronic device, the method comprising the steps of:
attaching to a fuel cell body outside a casing of an electronic device a hydrogen cartridge for supplying hydrogen to the fuel cell body, comprising a hydrogen storage chamber for storing hydrogen, a movable part which is movably connected to the hydrogen storage chamber and has a hydrogen flow path for allowing hydrogen to flow therethrough, and a hydrogen supply port which is formed integrally with the movable part and communicates with the hydrogen flow path, wherein the cartridge takes an open state in which the hydrogen storage chamber, the hydrogen flow path and the hydrogen supply port are connected to each other, or a closed state in which the hydrogen storage chamber, the hydrogen flow path and the hydrogen supply port are not connected to each other, by movement of the movable part or the hydrogen storage chamber;
then moving the movable part of the hydrogen cartridge; and
subsequently housing the hydrogen cartridge in the casing of the electronic device.
